(19) United States
(12) Patent Application Publication
(10) Pub. No.: US 2014/0307531 A1
(43) Pub. Date: Oct. 16, 2014

(54) ERGONOMIC WRISTBAND FOR A WATCH OR PIECE OF JEWELRY

(71) Applicant: Montres Jaquet Droz SA, La Chaux-de-Fonds (CH)

(72) Inventors: Maamar BOULARAS, Boudry (CH); Yann Leiggener, Neuchatel (CH)

(73) Assignee: Montres Jaquet Droz SA, La Chaux-de-Fonds (CH)

(21) Appl. No.: 14/246,634

(22) Filed: Apr. 7, 2014

(30) Foreign Application Priority Data
Apr. 12, 2013 (EP) 13163569.0

(51) Int. Cl. G04B 37/00; A44C 5/10

(52) U.S. Cl. CPC G04B 37/0008; A44C 5/107
USPC 368/282; 368/281; 63/4

(57) ABSTRACT

External extension piece for a case of a watch or jewel.

The extension piece is removable and includes, for housing an auxiliary function or a particular component, at least one housing which is delimited by a body of substantially annular shape, this body being held confined and clamped between, on the one hand, a base, and on the other hand, a cap including an aperture at the level of each this housing, by a securing and clamping means or by screws.

This cap includes a continuous elastic holding means around and inside this aperture.

This housing confines a spherical moving element with minimum play projecting through this aperture.

This application claims priority from European patent application No. 13163569.0 filed Apr. 12, 2013, the entire disclosure of which is hereby incorporated herein by reference.

### FIELD OF THE INVENTION

The invention concerns an external extension piece for a watch or jewel case.

The invention also concerns an equipped middle part for a watch or jewel case, including a middle part extending in an axial direction.

The invention further concerns a watch case including, on both sides of an equipped middle part of this type, a cover surrounding a crystal and a back cover.

The invention also concerns a wristband including at least one strand attached at one end thereof to said second securing means of an extension piece of this type, and at the other end to a third securing means comprised in a middle part of a case, said case including a back cover orthogonal to an axial direction.

The invention also concerns a watch including a wristband of this type.

The invention concerns the field of wristbands or bracelets for watches and pieces of jewellery, and more specifically wristbands extending around a central case carrying at least one watch movement and/or at least one piece of jewellery or similar component.

### BACKGROUND OF THE INVENTION

The customisation of watches and pieces of jewellery is a task which is always relatively complex and ill-suited to series production. Customisation concerns both the integration of the components desired by the user and the adaptation of the shape of the wristband generally carrying the watch or piece of jewellery.

The integration of auxiliary functions or particular components in an existing timepiece or piece of jewellery is often difficult, due to the small volume that generally remains available inside the case of a watch or piece of jewellery, and outside, to the presence of horns and for a watch, control members for the watch functions.

The usual crimping technique for holding decorative components such as cut stones, pearls or suchlike, is efficient but does not allow these decorative components to be easily changed to modify the general appearance of the watch or piece of jewellery.

The maintaining of a watch or jewel case on a wristband is often not sufficiently incorporated into the design of the case.

The usual horns are of average geometry and do not adapt very well to the dimensions of the smallest and largest wrists. The horns are, furthermore, often unsightly and may injure the user.

Most wristbands are difficult to customise to the morphology of the user. Entirely hinged wristbands are often either too loose or too tight, and do not ensure a regular, elegant shape in proximity to the case.

U.S. Pat. No. 2,682,759A in the name of CHALIKIAN describes hinged earrings with means of arresting in a particular position.

EP Patent Application No 0731395A2 in the name of CASIO describes a mechanism securing a bracelet band including a watch case provided at the periphery thereof with holding lugs, to which there are hooked oblique holding members provided with slots for guiding the bracelet band.

### SUMMARY OF THE INVENTION

The invention proposes to facilitate the integration of an additional component in a watch or jewel case, the additional component consists of a decorative part, or of a component with a technical function, such as an auxiliary control and/or display function.

The invention makes it possible to integrate these additional functions, both technical and aesthetic, in wristbands assembled around a case of small dimensions, as in the case of a ladies' watch or a jewel with a case containing a gem cabochon.

In a particular embodiment, this auxiliary function is attained around a spherical moving element movable in three dimensions and preferably manipulable by the user.

The invention also proposes to hold this type of watch or jewel wristband in an integrated manner relative to a central case.

The invention concerns a case without any horns.

The invention must allow customisation of a wristband, particularly an expensive wristband, to the morphology of the user, by implementing removable components, fixed in a secure manner after the sale, permitting a choice of pre-determined curvatures.

The invention therefore concerns an external extension piece for a watch or jewel case, characterized in that said extension piece is removable, and in that it includes, for housing an auxiliary function or a particular component, at least one housing which is delimited by a body of substantially annular shape, said body being held confined and clamped between, on the one hand, a base, and on the other hand, a cap including an aperture at the level of each said housing, by a securing and clamping means or by screws.

According to a feature of the invention, said cap includes a continuous elastic holding means around and inside said aperture.

According to a feature of the invention, said elastic holding means also forms a sealing means.

According to a feature of the invention, said extension piece includes at least one spherical moving element of a given diameter with minimal play inside said at least one housing and projecting through said aperture.

According to a feature of the invention, said extension piece carries, on both sides of a median axis, at a first end, a first means of securing to a said case at a first junction point and extending in a first direction, and at a second end, a second securing means for securing to a wristband strand at a second junction point and extending in a second direction, said first direction and said second direction being distinct and secant.

The invention also concerns an external extension piece for a watch or jewel case, said extension piece including, at a first end, a first means of securing to said case at a first junction point and extending in a first direction, and at a second end, a second securing means for securing to a wristband strand at a second junction point and extending in a second direction, characterized in that said extension piece is removable, and in that said second direction is not merged with said first direction and is secant therewith, and in that said extension piece forms a part of a wristband or bracelet, and in that said first securing means and said second securing means together define a first centre of curvature at the intersection of the normals to said first direction and to said second direction respectively derived from said first junction point and from said second junction point.

According to a feature of the invention, said extension piece is arranged for housing an auxiliary function and includes for this purpose at least one housing, which is delimited by a body of substantially annular shape, and said extension piece carries, on both sides of a median axis, said first securing means and said second securing means, said body being held confined and clamped between, on the one hand, a base, and on the other hand, a cap including an aperture at the level of each said housing, by securing and clamping means or by screws.

The invention also concerns an equipped middle part for a watch or jewel case, including a middle part extending in an axial direction, characterized in that it includes at least one fitting of inclined axis relative to said axial direction and arranged for receiving at least one locking trunnion comprised in said extension piece, said extension piece including, at a first end, a first means of securing to said case at a first junction point and extending in a first direction in which said at least one locking trunnion extends.

The invention further concerns an equipped middle part for a watch or jewel case, including a middle part extending in an axial direction, characterized in that the middle part includes at least one fitting of inclined axis relative to said axial direction and arranged for receiving at least one locking trunnion comprised in an external extension piece for a watch or jewel case, said extension piece including, at a first end, a first means of securing to said case at a first junction point and extending in a first direction, and at a second end, a second securing means for securing to a wristband strand at a second junction point and extending in a second direction, characterized in that said extension piece is removable, in that said second direction is not merged with said first direction and is secant therewith, in that said extension piece forms a part of a wristband, and in that said first securing means and said second securing means together define a first centre of curvature at the intersection of the normals to said first direction and to said second direction respectively derived from said first junction point and said second junction point, and in that at least one said locking trunnion extends in said first direction.

The invention further concerns a watch case including, on both sides of an equipped middle part of this type, a cover surrounding a crystal, and a back cover, characterized in that said cover also forms a cap comprised in said extension piece, in which at least one housing is delimited by a body confined and clamped between on the one hand, a base, and on the other hand, a said cap including an aperture at the level of each said housing, by a securing and clamping means or by screws.

The invention also concerns a wristband including at least one strand attached at one end thereof to said second means of securing said extension piece, and, at the other end to a third securing means comprised in a middle part of a case, said case including a back cover orthogonal to an axial direction, characterized in that said wristband is a hinged wristband of mean elliptical profile, wherein a first focus of the ellipse is formed by said centre of curvature.

The invention also concerns a watch including a wristband of this type.

### BRIEF DESCRIPTION OF THE DRAWINGS

Other features and advantages of the invention will appear upon reading the following detailed description, with reference to the annexed drawings, in which:

FIG. 1 shows a schematic, partial, transverse cross-sectional view in the main plane of the wristband of a watch including a wristband according to the invention, with a case having no horns confining an equipped middle part for receiving particular extension pieces, shown here, on both sides of the case, with a first extension piece confining a spherical moving element, and a second extension piece forming an end link of the wristband:

FIG. 2 shows, in a similar manner to FIG. 1, a detail of this first extension piece confining a spherical moving element.

FIG. 3 shows a schematic, transverse, cross-sectional view, in an orthogonal plane to that of FIG. 2, of the same first extension piece.

FIG. 4 shows a schematic top view of the middle part of the case of FIG. 1.

FIG. 5 shows a schematic top view of the case of FIG. 1 provided with the first extension piece.

FIG. 6 shows a schematic, transverse, cross-sectional view in a parallel plane to that of FIG. 3, of the securing and locking area of the first extension piece to the middle part.

FIG. 7 shows a schematic bottom view of the central body of the first extension piece, shown in transverse cross-section in FIG. 8 with the detail of a cross-section of a trunnion, and in a top view in FIG. 9.

FIG. 10 shows a schematic, transverse cross-sectional view in the main plane of the wristband of a wristwatch of elliptical profile, and FIG. 11 shows, in a similar manner, a wristband of round profile.

FIG. 12 shows an exploded view of the main components of a watch case provided with this type of first extension piece and confining a spherical moving element, such as a pearl.

### DETAILED DESCRIPTION OF PREFERRED EMBODIMENTS

The invention concerns the field of wristbands or bracelets for watches and pieces of jewellery, and more specifically wristbands extending around a central case carrying at least one watch movement and/or at least one piece of jewellery or similar component.

The invention proposes to hold this type of watch wristband in an integrated manner relative to the central case.

The invention is more specifically described here for a watch wristband carrying a watch case. The jeweller will know how to extrapolate its features to his own products.

Advantageously, the invention makes it possible to use a watch case without any horns.

The invention also endeavours to promote the creation of an area of determined curvature, and of large amplitude, around the watch case, to avoid the common discontinuity between the case and wristband, which is disagreeable for the user.

To answer all of these problems, the invention concerns an extension piece 1 external to watch case 2.

This extension piece 1 is devised, according to the invention, as the end of a wristband 10.

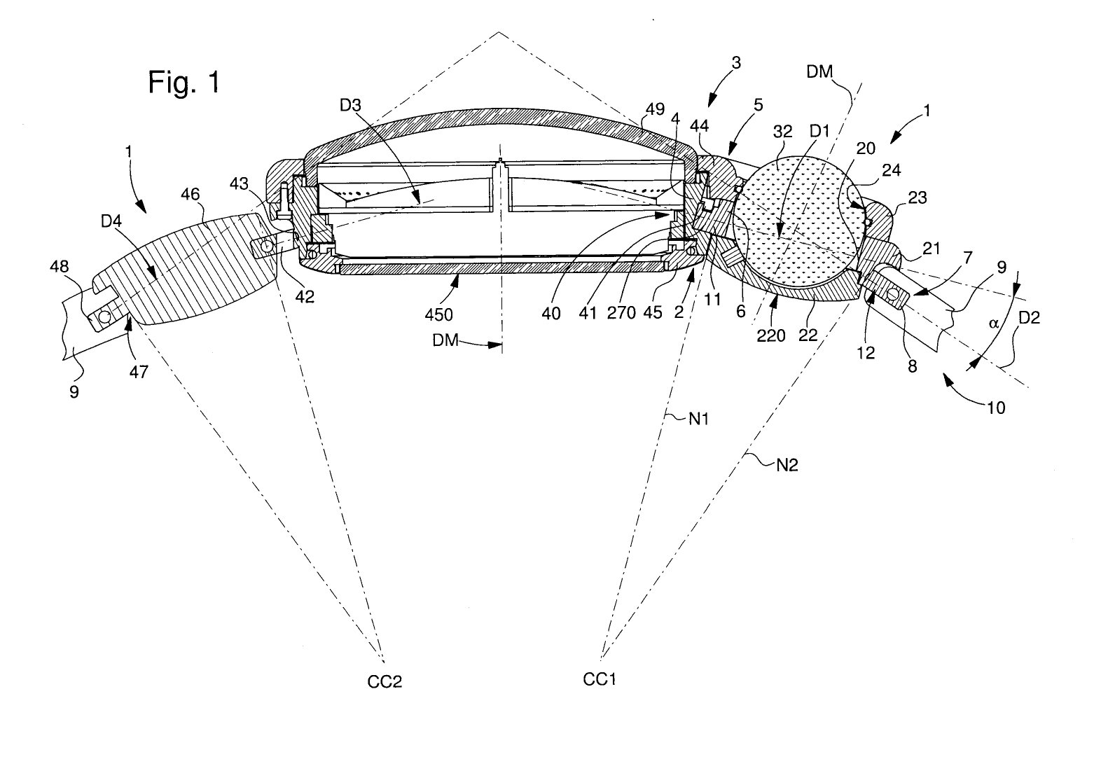

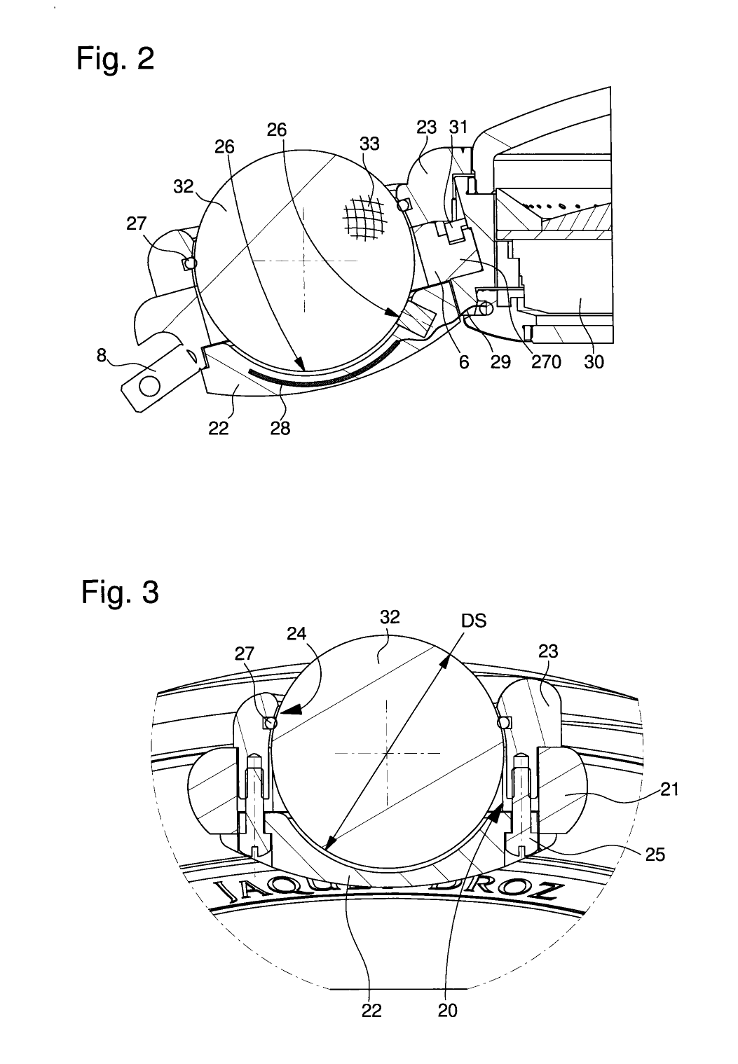

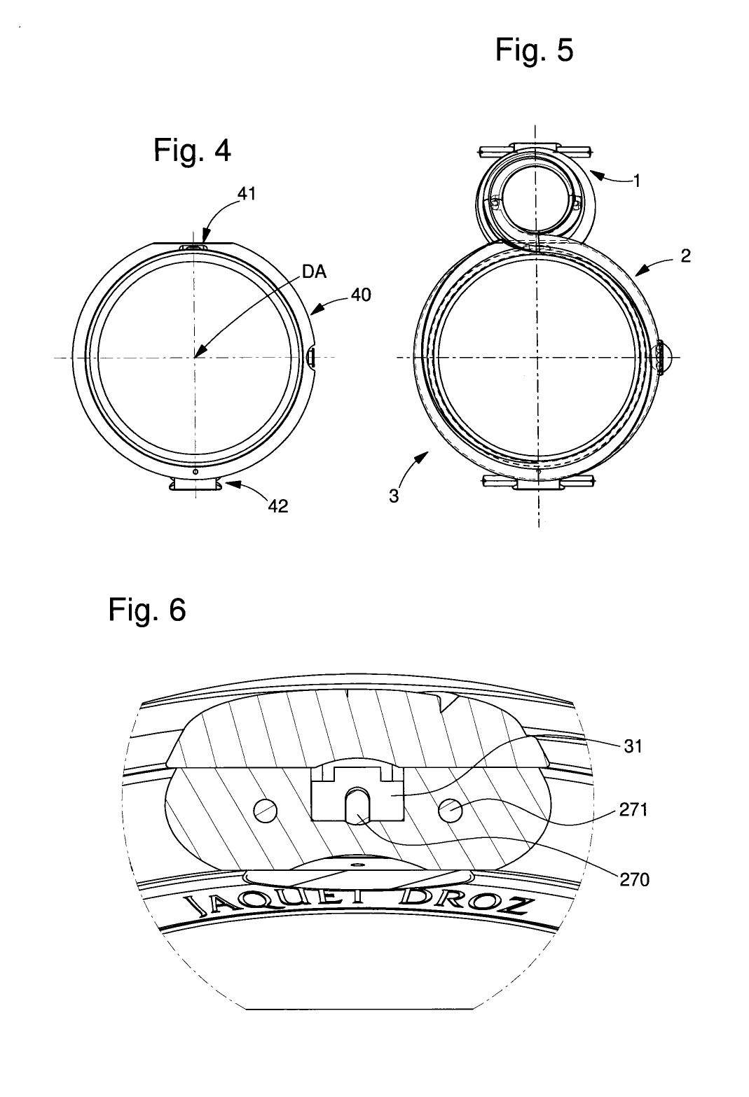

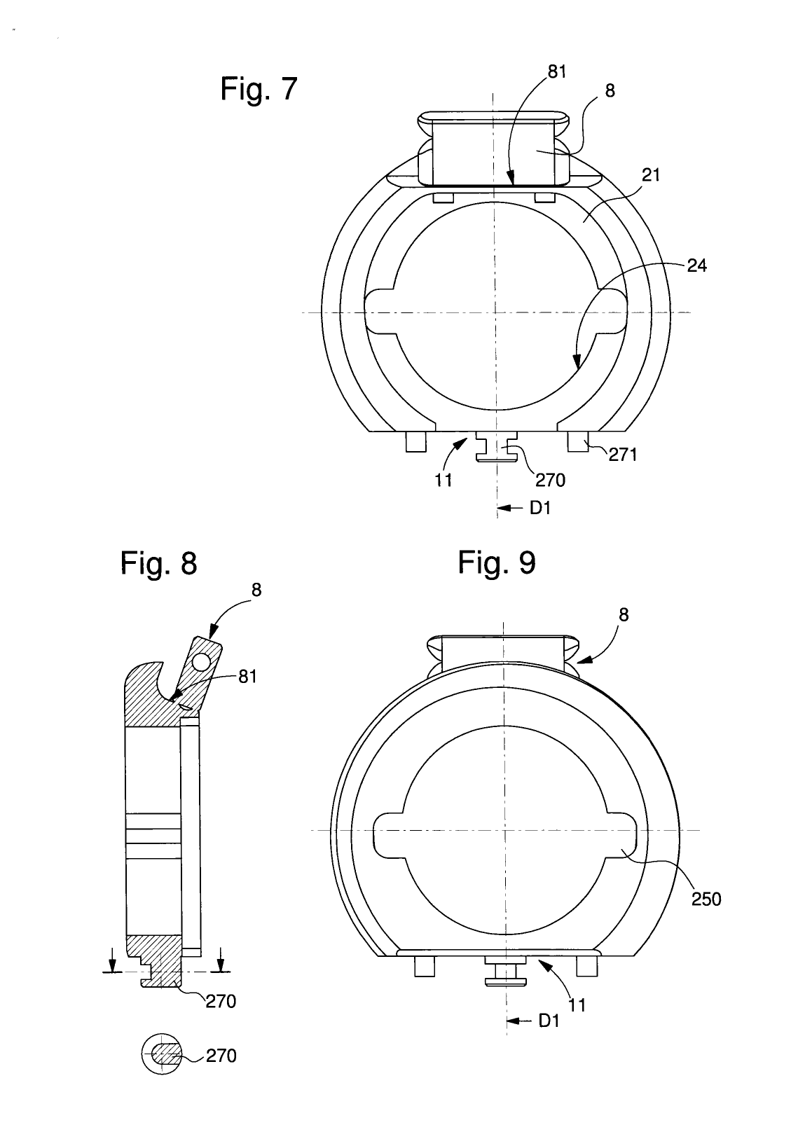

FIG. 1 illustrates, on one side of a case 2, a first extension piece 1 including particular features, and on the opposite side of case 2, another extension piece 1 formed of a particular wristband link 46.

The invention also proposes to integrate, in at least one extension piece extending the watch case, at least one auxiliary function, of a technical and/or aesthetic nature.

Thus, the invention concerns an external extension piece 1 for a case 2 of a watch 3 or a jewel.

According to the invention, this extension piece 1 is removable, and includes, for housing an auxiliary function or a particular component, at least one housing 20 which is delimited by a body 21 of substantially annular shape. Body 21 is held confined and clamped between, on the one hand, a base 22, and on the other hand, a cap 23 including an aperture 24 at the level of each housing 20, by a securing and clamping means 25 or by screws.

Preferably, this cap 23 includes a continuous elastic holding means 27 around and inside aperture 24.

Advantageously, this elastic holding means 27 also forms a sealing means.

In a preferred embodiment, extension piece 1 includes at least one spherical moving element 32 of given diameter DS moveable with minimum play inside at least one said housing 20 and projecting through the corresponding aperture 2.

This extension piece 1 includes, at a first end 5, a first means 6 of securing to case 2 at a first junction point 11. This first securing means 6 extends in a first direction D1.

Extension piece 1 includes, at a second end 7, a second securing means 8 for securing to a strand 9 of a wristband 10 at a second junction point 12.

According to the invention, extension piece 1 is removable, and said second securing means 8 extends in a second direction D2, not merged with first direction D1 and secant therewith.

Extension piece 1 forms a part of a wristband 10.

Said first securing means 6 and said second securing means 8 together define a first centre of curvature CC1 at the intersection of the normals to first direction D1 and to second direction D2 respectively derived from first junction point 11 and second junction point 12.

This extension piece thus makes it possible to give a particular angle to one end of the wristband, which is the resultant of a first angle of outlet of a middle part 4, and the angle that the first direction D1 and second direction D2 form together. In short, extension piece 1 creates a particular curvature of wristband 10 in immediate proximity to case 2.

It is therefore possible, with a given case 2, to form wristbands 10 having different shapes, by connecting to case 2 particular extension pieces 1 with different angles α between first direction D1 and second direction D2.

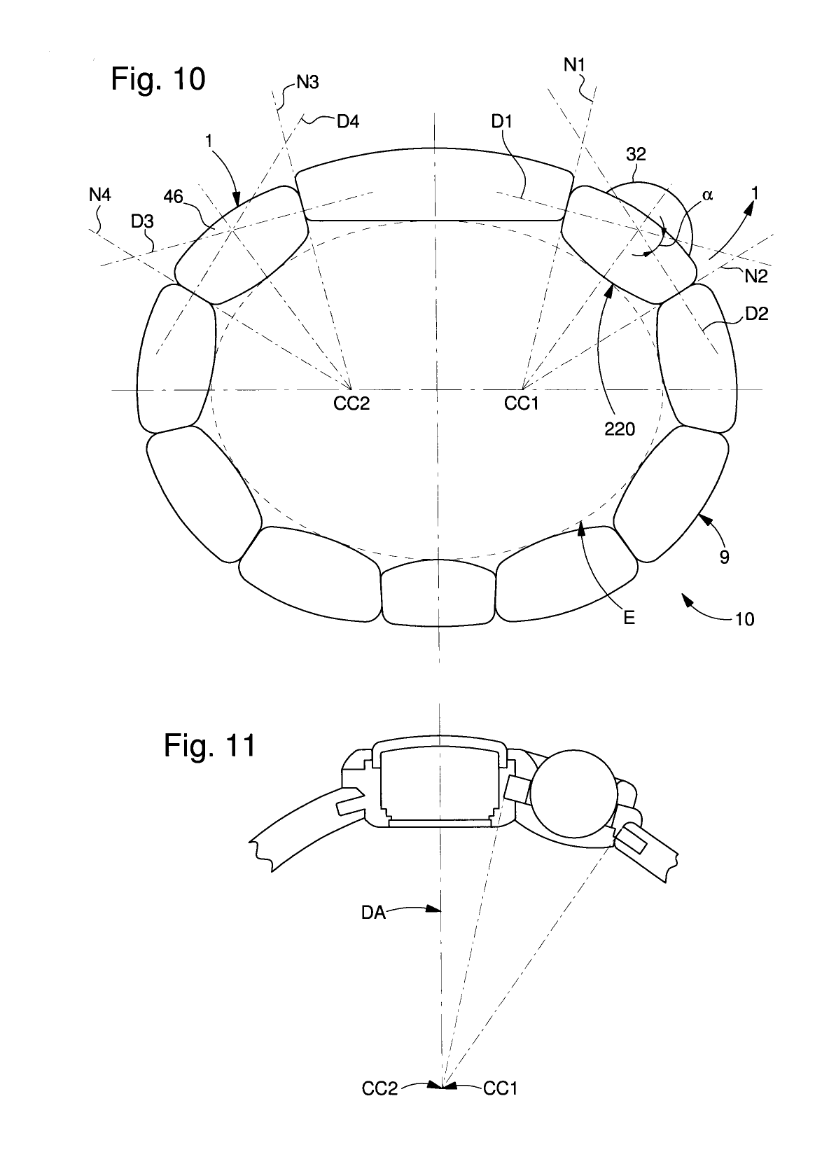

FIG. 10 illustrates a substantially elliptical wristband profile obtained with the invention. The user's wrist measurement determines the optimum excentring of the elliptical profile for maximum user comfort.

The choice of adapted extension pieces 1 makes it possible to move the foci of the ellipse further away or nearer, depending on the case, from the plane of symmetry of wristband 10. In a particular embodiment of this wristband, the centre of curvature CC1 forms a focus of the ellipse.

In a particular embodiment, this extension piece 1 is arranged for housing an auxiliary function, and includes for this purpose at least one housing 20. This housing 20 is delimited by a body 21 of substantially annular shape.

Extension piece 1 carries, on both sides of a median axis DM, first securing means 6 and second securing means 8. Body 21 is held confined and clamped between, on the one hand, a base 22, and on the other hand, a cap 23 including an aperture 24 at the level of each housing 20, by securing and clamping means 25 formed in particular by screws or suchlike.

When extension piece 1 is devised for receiving a moving component, the base 22 thereof includes at least one inner bearing surface 26 having a low friction coefficient, particularly “Teflon”, “Delrin”, POM or suchlike.

For holding this type of moving element in housing 20, cap 23 preferably includes a continuous elastic holding means 27 around and inside aperture 24, which ensures the neatness of housing 20 in addition to the elastic holding of the moving element. In a specific manner, this holding means 27 also forms a sealing means, and is made of elastomer, rubber, or similar (particularly 65 to 80 Shore A NBR).

In a specific manner, housing 20 is arranged for receiving a spherical body having a given diameter DS greater than the smallest dimension of said aperture 24, for holding said spherical body confined inside housing 20.

In this embodiment, the corresponding bearing surface 26 is circumscribed to a sphere of given diameter DS to which it is tangent at at least three points.

Elastic holding means 27 is then circumscribed to a sphere of given diameter DS to which it is tangent over its entire length. “Tangents” means that the compressed profile thereof is geometrically tangent to the sphere, and preferably on a circle.

When the moving element inserted inside housing 20 of the extension piece fulfils a technical function, such as a cursor, control member, physical quantity sensor, display member, or other element, base 22 includes, on at least one bearing surface 26, a detection means 28, which is arranged to detect the position in space of said moving element inserted inside housing 20.

Base 22 preferably includes a transmission means 29, which is arranged to transmit a signal emitted by detection means 28 to a drive and control device 30, which may be located in wristband 10, or preferably inside case 2, or even outside wristband 10 and the case 2 carried thereby. The drive and control device 30 is advantageously incorporated in the case, for example in the watch movement, and allows the display and/or adjustment of particular functions controlled by moving element 32.

Conversely, moving element 32 may also behave as a receiver of motion pulses originating from a watch movement, for example for a three-dimensional moon or earth phase display, the heavenly body being symbolised by a sphere driven by magnetic fields or suchlike generated inside case 2.

The same extension piece 1 may include several moving parts 32, each inside a housing 20, transmitting and/or receiving, in linear or rotational motions.

In a particular embodiment of the first securing means, extension piece 1 includes, on body 21, at least one locking trunnion 270 projecting at the first junction point 11 in first direction D1 and a locking shim 31 for the axial locking of said trunnion 270 when cap 23 is clamped onto base 22. For positioning in the other directions, body 21 includes one or more pins 271, or stop surfaces, or similar.

In a preferred embodiment illustrated in FIG. 1, extension piece 1 in the variant thereof with at least one housing 20, includes at least one spherical moving element of given diameter DS moveable with minimum play inside at least one housing 20 and projecting through aperture 24. This spherical moving element may be formed by a pearl, a bead or similar.

Advantageously, this at least one spherical moving element 32 includes a passive means 33 forming a cursor for identifying its position in space.

Spherical moving element 32 can thus operate like the cursor of a mouse, the mouse body being formed by extension piece 1.

Detection means 28 is then arranged to detect, either the position of moving element 32, and/or its speed, and/or its acceleration, relative to a system of reference coordinates not detailed here.

The invention also concerns an equipped middle part 40, derived from the transformation of a middle part 4 able to be integrated in a case 2, and which includes at least one interface area with extension piece 1, and preferably two substantially diametrically opposite interface areas relative to the median axis DM of middle part 4, defining an axial direction DA in which middle part 4 substantially extends.

Case 2 and preferably equipped middle part 4, extends substantially along a plane P, in principle tangent to back cover 45 of case 2. The equipped middle part 40 is arranged so that, in one of these interface areas, when extension piece 1 is fixed to equipped middle part 40, its first direction D1 is oblique relative to plane P.

This equipped middle part 40 thus includes at least one fitting 41 of inclined axis relative to the axial direction DA and arranged to receive first means 6 of securing an extension piece 1 and in particular at least one locking trunnion 27 comprised, in first direction D1, in said extension piece 1.

As seen in FIGS. 1 and 10, the equipped middle part includes, in a particular embodiment, substantially diametrically opposite said fitting 41, a third securing means 42 for securing, either to a strand 9 of a wristband 10 at a third junction point 43 and extending in a third direction D3 not merged with first direction D1 and second direction D2 and secant therewith, or as illustrated in the Figures, to another particular extension piece 1 formed of an end link 46 and defining a third direction D3 and a fourth direction D4. Preferably, third direction D3 is symmetrical to first direction D1, and fourth direction D4 is symmetrical to second direction D2, and they form the same angle α between them. Thus, the contact between the user's wrist and wristband 10 is symmetrical on both sides of case 2.

The invention also concerns a case 2 for a watch 3 including, on both sides of equipped middle part 40, a cover 44 surrounding a crystal 49 in a conventional manner which is not detailed here, and a back cover 45.

According to the invention, cover 44 of case 2 also forms a cap 23 comprised in at least one extension piece 1, in which at least one housing 20 is delimited by a body 21 held confined and clamped between, on the one hand, a base 22 and on the other hand, a cap 23 including an aperture 24 at the level of each housing 20, by a securing and clamping means 25 or by screws.

FIG. 1 illustrates a case wherein cover 44 covers middle part 4 and a single extension piece 1. In this version, the assembly formed by middle part 4 and extension piece 1 forms, as seen in a top view in FIG. 5, the figure “8” characteristic of the Applicant's products. It is naturally possible to envisage a symmetrical configuration in which cover 44 also covers end link 46.

The assembling of the assembly is facilitated in this advantageous embodiment with a single component forming the cover of the case and the cap of the extension piece. The sequence includes the following operations:
assembling body 21 to middle part 4, positioning the bezel formed by cover 44 also forming cap 23 (particularly in a figure of eight) with screws at six o'clock on the case via a screw traversing an insert, positioning crystal 49 covering only middle part 4 (in the largest part of the eight);
inserting moving element 32 in body 21, screwing on base 22 of extension piece 1 with screws 25 which will also hold cap 23 and press the latter onto bolt 31 to immobilise trunnion 270. Moving element 32 is supported by studs F made of POM or similar forming bearing surface 26, on the back cover, and by an O-ring joint 27 on the contour of aperture 24 of cap 23;
casing up the dial and movement, seen in FIG. 1, in middle part 4, and snap fitting or otherwise assembling back cover 45.

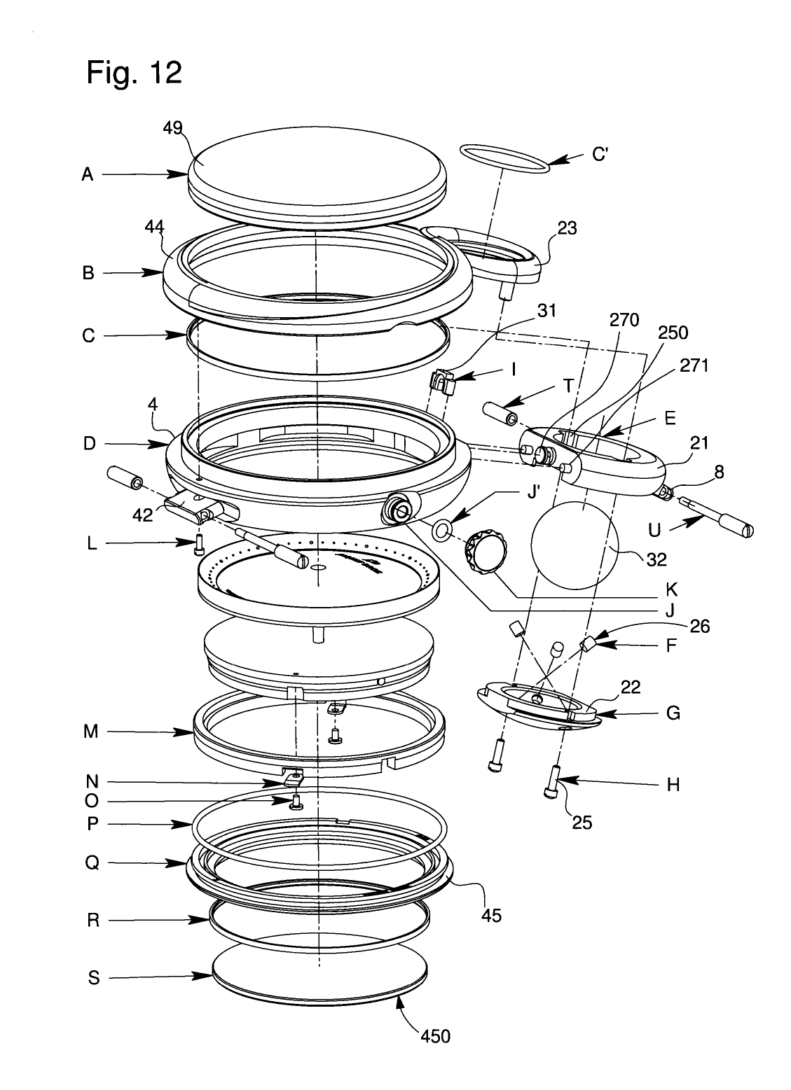

In this particular non-limiting implementation, whose references are shown in FIG. 12, middle part 4 carries at three o'clock a tube J welded for housing the winding and time setting crown K, and for receiving sealing gaskets. The middle part also carries, at six o'clock, an obliquely mounted insert 42, preferably pre-mounted by guide and orientation pins, then welded. The same assembly method is preferably applied to an insert forming the second securing means 8 applied to body 21 of the extension piece. The oblique fitting for housing trunnion 270 of the extension piece, and orientation pins 271 is located at twelve o'clock.

Unscrewing screws 25 underneath base 22 releases bolt 31 and allows extension piece 1 to be removed, and replaced by another, of different geometry and/or carrying another function or another decorative element.

The invention also concerns a wristband 10 including at least one strand 9 attached at one end thereof to second securing means 8 of extension piece 1, and at the other end, either to third securing means 42 comprised in a middle part 40 of a case 2, or to a fourth securing means 48 comprised in an end link 46.

Case 2 preferably includes a back cover 45 orthogonal to axial direction DA.

In a particular embodiment, wristband 10 is a hinged wristband having an elliptical mean profile, wherein the first focus of the ellipse is formed by the first centre of curvature CC1.

In the particular embodiment of FIG. 1, wristband 10 includes a second extension piece 1 formed of an end link 46, attached to third securing means 42. This end link 46 includes, at a fourth junction point 47, fourth securing means 48 for securing strand 9 oriented in a fourth direction D4 symmetrical to second direction D2. Third securing means 42 and fourth securing means 48 together define a second centre of curvature CC2 which is defined by the intersection of the normals to third direction D3 and to fourth direction D4 respectively derived from the third junction point 43 and from fourth junction point 47.

In this particular embodiment, the second focus of the ellipse is formed by the second centre of curvature CC2 defined by a second extension piece 1 such as end link 46, as shown in FIGS. 1 and 10.

In a specific embodiment, the ellipse is reduced to a circle, wristband 10 is a hinged wristband of mean circular profile, and the first centre of curvature CC1 and the second centre of curvature CC2 are merged.

In a variant, strand 9 includes an intermediate clasp.

In another variant, it is one of extensions 1, notably end link 46, which includes the clasp for wristband 10.

In a particular variant, the opening/closing of the clasp is controlled by the movement of a moving element 32 inserted inside a housing 20 of an extension piece 1.

The invention also concerns a watch 3 including a wristband 10 of this type.

What is claimed is:

1. An external extension piece for a case of a watch or jewel, wherein said extension piece is removable, and in that the extension piece includes, for housing an auxiliary function or a particular component, at least one housing which is delimited by a body of substantially annular shape, said body being held confined and clamped between, on the one hand, a base, and on the other hand, a cap including an aperture at the level of each said housing, by a securing and clamping means or by screws.

2. The extension piece according to claim 1, wherein said cap includes a continuous elastic holding means around and inside said aperture (24).

3. The extension according to the preceding claim, wherein said elastic holding means also forms a sealing means.

4. The extension piece according to claim 1, wherein said base includes at least one bearing surface having a low friction coefficient.

5. The extension piece according to claim 1, wherein said housing is arranged for receiving a spherical body of given diameter greater than the smallest dimension of said aperture.

6. The extension piece according to claim 4, wherein said housing is arranged for receiving a spherical body of given diameter greater than the smallest dimension of said aperture and in that said at least one bearing surface is circumscribed to a sphere of said given diameter to which said surface is tangent at at least three points.

7. The extension piece according to claim 2, wherein said housing is arranged for receiving a spherical body of given diameter greater than the smallest dimension of said aperture and in that said elastic holding means is circumscribed to a sphere of said given diameter to which said means over the entire length thereof.

8. The extension piece according to claim 1, wherein said base includes, on at least one bearing surface, a detection means arranged to detect the position in space of a moving element inserted in said housing, and a transmission means arranged to transmit a signal emitted by said detection means to a drive and control device.

9. The extension piece according to claim 1, wherein said extension piece includes at least one spherical moving element of a given diameter with minimal play inside said at least one housing and projecting through said aperture.

10. The extension piece according to the preceding claim, wherein said at least one spherical moving element includes a passive means forming a cursor for identifying the position thereof in space.

11. The extension piece according to claim 1, wherein said extension piece carries, on both sides of a median axis, at a first end, a first means of securing to a said case at a first junction point and extending in a first direction, and at a second end, a second securing means for securing to a strand of a wristband at a second junction point and extending in a second direction, said first direction and said second direction being distinct and secant.

12. The extension piece according to the preceding claim, wherein said extension piece includes at least one locking trunnion projecting at said first junction point in said first direction, and a locking shim for the axial locking of said trunnion when said cap is clamped onto said base.

13. An equipped middle part for a case of a watch or jewel, including a middle part extending in an axial direction, wherein said equipped middle part includes said at least one fitting of inclined axis relative to said axial direction and arranged for receiving at least one locking trunnion comprised in an extension piece according to claim 1, said extension piece including, at a first end, a first means of securing to said case at a first junction point and extending in a first direction in which said at least one locking trunnion extends.

14. An equipped middle part for a case for a watch or jewel, including a middle part extending in an axial direction, wherein the middle part includes at least one fitting of inclined axis relative to said axial direction and arranged for receiving at least one locking trunnion comprised in an external extension piece for a case for a watch or jewel, said extension piece including, at a first end, a first means of securing to said case at a first junction point and extending in a first direction, and at a second end, a second means for securing to a strand of a wristband at a second junction point and extending in a second direction, wherein said extension piece is removable, in that said second direction is not merged with said first direction and is secant therewith, in that said extension piece forms a part of a wristband, and in that said first securing means and said second securing means together define a first centre of curvature at the intersection of the normals to said first direction and to said second direction respectively derived from said first junction point and from said second junction point, and in that at least one said locking trunnion extends in said first direction.

15. The equipped middle part according to claim 13, wherein said middle part includes, substantially diametrically opposite said fitting, a third securing means for securing to a strand of a wristband at a third junction point and extending in a third direction which is not merged with said first direction and said second direction and is secant therewith.

16. The equipped middle part according to claim 14, wherein said middle part includes, substantially diametrically opposite said fitting, a third securing means for securing to a strand of a wristband at a third junction point and extending in a third direction which is not merged with said first direction and said second direction and is secant therewith.

17. A case for a watch including, on both sides of an equipped middle part according to claim 13, a cover surrounding a crystal, and a back cover, wherein said cover also forms a cap comprised in said extension piece, in which at least one housing is delimited by a body held confined and clamped between on the one hand, a base, and on the other hand, a said cap including an aperture at the level of each said housing, by a securing and clamping means or by screws.

18. A case for a watch including, on both sides of an equipped middle part according to claim 14, a cover surrounding a crystal, and a back cover, wherein said cover also forms a cap comprised in said extension piece, in which at least one housing is delimited by a body held confined and clamped between on the one hand, a base, and on the other hand, a said cap including an aperture at the level of each said housing, by a securing and clamping means or by screws.

19. A wristband including at least one strand attached at one end thereof to said second securing means of a said extension piece according to claim 1, and, at the other end to a third securing means comprised in a middle part of a case, said case including a back cover orthogonal to an axial direction, wherein said wristband is a hinged wristband of elliptical mean profile, wherein a first focus of the ellipse is formed by said centre of curvature.

20. The wristband according to the preceding claim, wherein the wristband includes, attached to said third securing means, an end link including, at a fourth junction point, a fourth securing means for securing said strand oriented in a fourth direction symmetrical to said second direction, and in that said third securing means and said fourth securing means together define a second centre of curvature which is defined by the intersection of the normals to said third direction and to said fourth direction respectively derived from said third junction point and from said fourth junction point and wherein a second focus of said ellipse is formed by said second centre of curvature.

21. The wristband according to claim 19, wherein said wristband is in a hinged wristband of circular mean profile.

22. The wristband according to claim 19, wherein said strand includes an intermediate clasp.

23. The wristband according to claim 20, wherein said strand includes an intermediate clasp, and in that said end link forms said intermediate clasp.

24. A watch including a wristband according to claim 19.
